(19) United States
(12) Patent Application Publication
(10) Pub. No.: US 2018/0227934 A1
(43) Pub. Date: Aug. 9, 2018

(54) Group Common Physical Downlink Control Channel Design In Mobile Communications

(71) Applicant: MediaTek Inc., Hsinchu City (TW)

(72) Inventors: Weidong Yang, San Diego, CA (US); Chien-Hwa Hwang, Hsinchu City (TW)

(21) Appl. No.: 15/889,079

(22) Filed: Feb. 5, 2018

Related U.S. Application Data
(60) Provisional application No. 62/455,533, filed on Feb. 6, 2017.

(51) Int. Cl. H04W 72/12; H04W 72/14; H04W 72/04; H04W 52/14

(52) U.S. Cl. CPC H04W 72/121; H04W 52/146; H04W 72/0446; H04W 72/14

(57) ABSTRACT

Various solutions for group common physical downlink control channel (GC PDCCH) design with respect to user equipment and network apparatus in mobile communications are described. An apparatus may monitor a GC PDCCH. The apparatus may receive a slot type indication for at least one slot from the GC PDCCH. The apparatus may further perform at least one of transmission and reception according to the slot type indication.

### CROSS REFERENCE TO RELATED PATENT APPLICATION(S)

The present disclosure is part of a non-provisional application claiming the priority benefit of U.S. Patent Application No. 62/455,533, filed on 6 Feb. 2017, the content of which is incorporated by reference in its entirety.

### TECHNICAL FIELD

The present disclosure is generally related to mobile communications and, more particularly, to group common physical downlink control channel design with respect to user equipment and network apparatus in mobile communications.

### BACKGROUND

Unless otherwise indicated herein, approaches described in this section are not prior art to the claims listed below and are not admitted as prior art by inclusion in this section.

There are various well-developed and well-defined cellular communications technologies in telecommunications that enable wireless communications using mobile terminals, or user equipment (UE). For example, the Global System for Mobile communications (GSM) is a well-defined and commonly used communications system, which uses time division multiple access (TDMA) technology, which is a multiplex access scheme for digital radio, to send voice, video, data, and signaling information (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Long-Term Evolution (LTE), as well as its derivatives such as LTE-Advanced and LTE-Advanced Pro, is a standard for high-speed wireless communication for mobile phones and data terminals. In addition, there are some newly developed next generation communication technologies such as 5th Generation (5G), New Radio (NR), Internet of Things (IoT) and Narrow Band Internet of Things (NB-IoT). These communication technologies are developed for higher speed transmission and serving for huge number of devices including machine type devices.

In the NR communication network or the newly developed next generation communication network, a group common physical downlink control channel (GC PDCCH) is introduced for transmitting control information from the network apparatus to the UEs. The GC PDCCH may refer to a channel (e.g., either a PDCCH or a separately designed channel) that carries information intended for a group of UEs. The GC PDCCH may be used for carrying some important information for the UEs to perform corresponding operations. However, the contents or the use cases of the GC PDCCH are not well defined or specified yet. What information should be contained in the GC PDCCH and the functionality of the GC PDCCH are still under discussion.

Accordingly, it is important for the UE to receive the information carried in the GC PDCCH and perform the corresponding operations according to the received information. Therefore, in developing new communication systems, it is needed to properly design and define the contents of the GC PDCCH.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to group common physical downlink control channel design with respect to user equipment and network apparatus in mobile communications.

In one aspect, a method may involve an apparatus monitoring a group common physical downlink control channel (GC PDCCH). The method may also involve the apparatus receiving a slot type indication for at least one slot from the GC PDCCH. The method may further involve the apparatus performing at least one of transmission and reception according to the slot type indication.

In one aspect, an apparatus may comprise a transceiver capable of wirelessly communicating with a plurality of nodes of a wireless network. The apparatus may also comprise a processor communicatively coupled to the transceiver. The processor may be capable of monitoring a group common physical downlink control channel (GC PDCCH). The processor may also be capable of receiving a slot type indication for at least one slot from the GC PDCCH. The processor may further be capable of performing at least one of transmission and reception according to the slot type indication.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a block diagram of an example communication apparatus and an example network apparatus in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to group common physical downlink control channel design with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

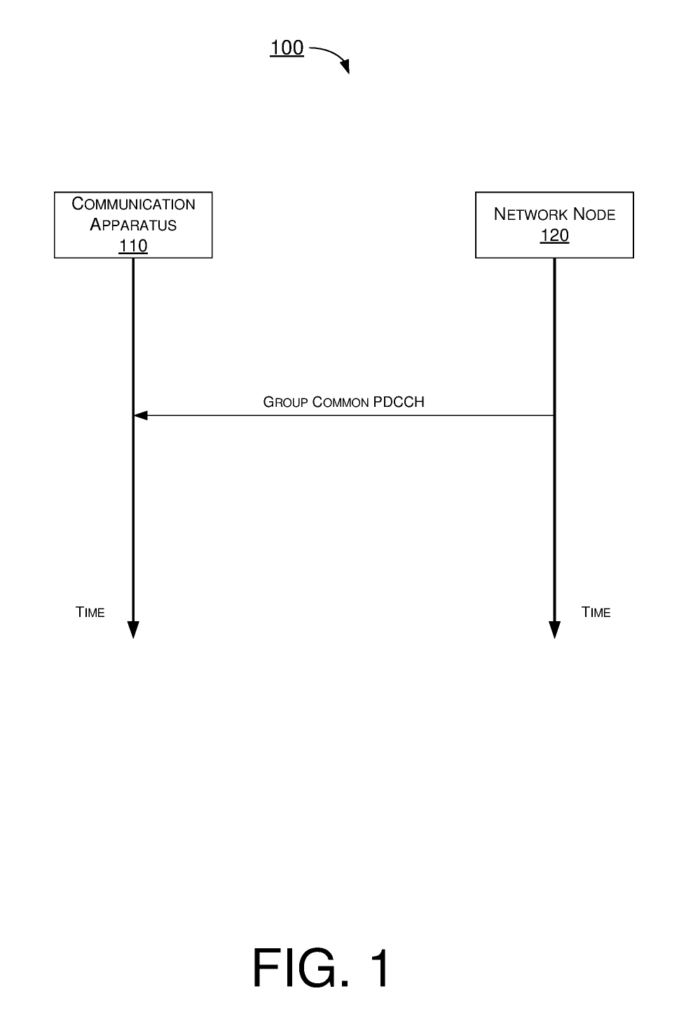

FIG. 1 illustrates an example scenario 100 under schemes in accordance with implementations of the present disclosure. Scenario 100 involves a user equipment (UE) 110 and a network apparatus 120, which may be a part of a wireless communication network (e.g., a Long Term Evolution (LTE) network, a LTE-Advanced network, a LTE-Advanced Pro network, a 5th Generation (5G) network, a New Radio (NR) network, an Internet of Things (IoT) network or a Narrow Band Internet of Things (NB-IoT) network). Network apparatus 120 may be configured to transmit control information to a plurality of UEs in a group common physical downlink control channel (GC PDCCH). The GC PDCCH may refer to a channel (e.g., either a PDCCH or a separately designed channel) that carries information intended for a group of UEs. The information carried in the GC PDCCH may comprise, for example and without limitation, at least one of slot structure information, slot format information, indication of control region, duration of control resource set and transmission duration of a burst. After receiving the GC PDCCH, the UEs may be able to perform corresponding operations according to the information received from the GC PDCCH. For example, with the information of duration of control resource set, the UE may be able to skip blind detection for PDCCHs at symbols not used by PDCCHs in the slot.

Specifically, UE 110 may be configured to monitor the GC PDCCH from network apparatus 120. UE 110 may receive a slot type indication for at least one slot from the GC PDCCH. The slot type indication may be used to indicate the transmission type for a slot or for a plurality of slots. The slot type indication may indicate, for example and without limitation, a downlink slot, an uplink slot, a downlink priority slot and an uplink priority slot. UE 110 may be configured to perform at least one of transmission, reception and corresponding operations according to the slot type indication. For example, in an event that the indicated slot type for a slot is an uplink slot, it means that the slot is configured for the UE to perform uplink transmission. The UE may be able to skip blind detection for PDCCH for that slot. The downlink priority slot means that downlink transmission may have higher priority than uplink transmission in that slot. The uplink priority slot means that uplink transmission may have higher priority than downlink transmission in that slot.

In some implementations, UE 110 may be further configured to receive slot type parameters from the GC PDCCH. The slot type parameters may comprise timing or duration for performing the clear channel assessment (CCA). UE 110 may be configured to perform the CCA according to the slot type parameters. The CCA region may be configured for UE 110 to sense whether any signals may be transmitted from other nodes before transmitting uplink signals to the network apparatus. After sensing the transmission from other nodes, UE 110 may be configured to make decisions according to the sensing result. The decisions may comprise at least one of determining whether to transmit signals or not, adjusting a transmission power level and determining a MCS level.

In some implementations, UE 110 may be further configured to receive slot type parameters from the GC PDCCH. The slot type parameters may indicate whether to transmit a busy signal. UE 110 may be configured to determine whether to transmit the busy signal according to the slot type parameters. The busy signal may be used to facilitate the sensing mechanism at other nodes. Specifically, the busy signal may have some structures similar to, for example and without limitation, sounding reference signal (SRS), channel state information-reference signal (CSI-RS) or demodulation-reference signal (DM-RS). The busy signal may be used for detecting signal strength. Additional channel estimation and advanced precoding schemes may be conducted based on the busy signal. The busy signal may further comprise the identity information and/or the beam direction information of the transmitting node. The busy signal may also be used to indicate that a specific channel may be occupied for transmission. After receiving the busy signal, the receiving node may be aware of the identity, the beam direction, or the possible transmission from the transmitting node and may use these information for further decisions.

In some implementations, UE 110 may be further configured to receive slot type parameters from the GC PDCCH. The slot type parameters may comprise a power detection threshold. UE 110 may be configured to determine whether to transmit uplink signals according to the power detection threshold. UE 110 may be configured to perform the CCA or listen before talk (LBT) assessment before transmitting uplink signals to avoid signal interferences. UE 110 may be configured to detect the power level from other nodes and compare the detected power level with the power detection threshold. For example, in an event that the detected power level is greater than the power detection threshold, UE 110 may be configured not to transmit the uplink signals. The power detection threshold may be variant depending on the slot type of a slot.

In some implementations, UE 110 may be further configured to receive slot type parameters from the GC PDCCH. The slot type parameters may comprise an uplink power control rule. UE 110 may be configured to transmit uplink signals according to the uplink power control rule. The uplink power level may be different for different slots or for different UEs. The network apparatus may use the uplink power control rule to specify the uplink power transmitted from each UE. The uplink power control rule may also be variant depending on the slot type of a slot. For example, the uplink power control rule for the uplink priority slot may be different from the uplink power control rule for the downlink priority slot.

In some implementations, the slot type or the slot type parameters may be pre-configured via radio resource control (RRC) signaling. Specifically, the network apparatus may transmit a plurality of possible options or configurations for the slot type or the slot type parameters to the UEs. The UE may store these possible options or configurations. Then, the network apparatus may indicate one of these possible options or configurations via the GC PDCCH signaling. After receiving the GC PDCCH signaling, the UE may be able to apply one of the pre-stored options or configurations. Accordingly, the overhead of the GC PDCCH signaling may be reduced.

### Illustrative Implementations

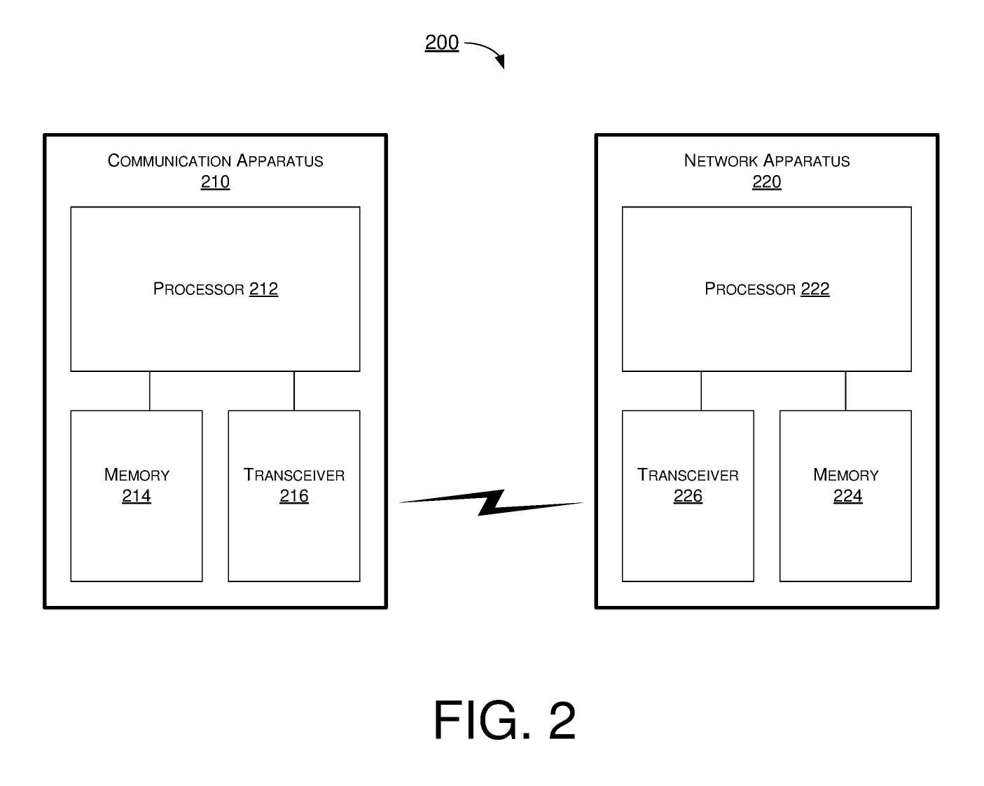

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to GC PDCCH design with respect to user equipment and network apparatus in wireless communications, including scenario 100 described above as well as process 300 described below.

Communication apparatus 210 may be a part of an electronic apparatus, which may be a user equipment (UE) such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT or NB-IoT apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, or one or more complex-instruction-set-computing (CISC) processors. Communication apparatus 210 may include at least some of those components shown in FIG. 2 such as a processor 212, for example, communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus, which may be a network node such as a base station, a small cell, a router or a gateway. For instance, network apparatus 220 may be implemented in an eNodeB in a LTE, LTE-Advanced or LTE-Advanced Pro network or in a gNB in a 5G, NR, IoT or NB-IoT network. Alternatively, network apparatus 220 may be implemented in the form of one or more IC chips such as, for example and without limitation, one or more single-core processors, one or more multi-core processors, or one or more CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE and network apparatus 220 is implemented in or as a network node of a communication network.

In some implementations, processor 222 may be configured to transmit, via transceiver 226, control information to a plurality of UEs in a GC PDCCH. The GC PDCCH may refer to a channel (e.g., either a PDCCH or a separately designed channel) that carries information intended for a group of UEs. The information carried in the GC PDCCH may comprise, for example and without limitation, at least one of slot structure information, slot format information, indication of control region, duration of control resource set and transmission duration of a burst. After receiving the GC PDCCH, the UEs may be able to perform corresponding operations according to the information received from the GC PDCCH. For example, with the information of duration of control resource set, the UE may be able to skip blind detection for PDCCHs at symbols not used by PDCCHs in the slot.

In some implementations, processor 212 may be configured to monitor the GC PDCCH from network apparatus 220. Processor 212 may be configured to receive, via transceiver 216, a slot type indication for at least one slot from the GC PDCCH. The slot type indication may be used to indicate the transmission type for a slot or for a plurality of slots. The slot type indication may indicate, for example and without limitation, a downlink slot, an uplink slot, a downlink priority slot and an uplink priority slot. Processor 212 may be configured to perform at least one of transmission, reception and corresponding operations according to the slot type indication. For example, in an event that the indicated slot type for a slot is an uplink slot, it means that the slot is configured for communication apparatus 210 to perform uplink transmission. Processor 212 may be able to skip blind detection for PDCCH for that slot. The downlink priority slot means that downlink transmission may have higher priority than uplink transmission in that slot. The uplink priority slot means that uplink transmission may have higher priority than downlink transmission in that slot.

In some implementations, processor 212 may be further configured to receive slot type parameters from the GC PDCCH. The slot type parameters may comprise timing or duration for performing the clear channel assessment (CCA). Processor 212 may be configured to perform the CCA according to the slot type parameters. The CCA region may be configured for communication apparatus 210 to sense whether any signals may be transmitted from other nodes before transmitting uplink signals to the network apparatus. After sensing the transmission from other nodes, processor 212 may be configured to make decisions according to the sensing result. The decisions may comprise at least one of determining whether to transmit signals or not, adjusting a transmission power level and determining a MCS level.

In some implementations, processor 212 may be further configured to receive slot type parameters from the GC PDCCH. The slot type parameters may indicate whether to transmit a busy signal. Processor 212 may be configured to determine whether to transmit the busy signal according to the slot type parameters. The busy signal may be used to facilitate the sensing mechanism at other nodes. Specifically, the busy signal may have some structures similar to, for example and without limitation, sounding reference signal (SRS), channel state information-reference signal (CSI-RS) or demodulation-reference signal (DM-RS). The busy signal may be used for detecting signal strength. Additional channel estimation and advanced precoding schemes may be conducted based on the busy signal. The busy signal may further comprise the identity information and/or the beam direction information of the transmitting node. The busy signal may also be used to indicate that a specific channel may be occupied for transmission. After receiving the busy signal, the receiving node may be aware of the identity, the beam direction, or the possible transmission from the transmitting node and may use these information for further decisions.

In some implementations, processor 212 may be further configured to receive slot type parameters from the GC PDCCH. The slot type parameters may comprise a power detection threshold. Processor 212 may be configured to determine whether to transmit uplink signals according to the power detection threshold. Processor 212 may be configured to perform the CCA or listen before talk (LBT) assessment before transmitting uplink signals to avoid signal interferences. Processor 212 may be configured to detect the power level from other nodes and compare the detected power level with the power detection threshold. For example, in an event that the detected power level is greater than the power detection threshold, processor 212 may be configured not to transmit the uplink signals. The power detection threshold may be variant depending on the slot type of a slot.

In some implementations, processor 212 may be further configured to receive slot type parameters from the GC PDCCH. The slot type parameters may comprise an uplink power control rule. Processor 212 may be configured to transmit uplink signals according to the uplink power control rule. The uplink power level may be different for different slots or for different UEs. Network apparatus 220 may use the uplink power control rule to specify the uplink power transmitted from each UE. The uplink power control rule may also be variant depending on the slot type of a slot. For example, the uplink power control rule for the uplink priority slot may be different from the uplink power control rule for the downlink priority slot.

In some implementations, the slot type or the slot type parameters may be pre-configured via radio resource control (RRC) signaling. Specifically, processor 222 may transmit a plurality of possible options or configurations for the slot type or the slot type parameters to communication apparatus 210. Processor 212 may store these possible options or configurations in memory 214. Then, processor 222 may indicate one of these possible options or configurations via the GC PDCCH signaling. After receiving the GC PDCCH signaling, processor 212 may be able to apply one of the pre-stored options or configurations. Accordingly, the overhead of the GC PDCCH signaling may be reduced.

### Illustrative Processes

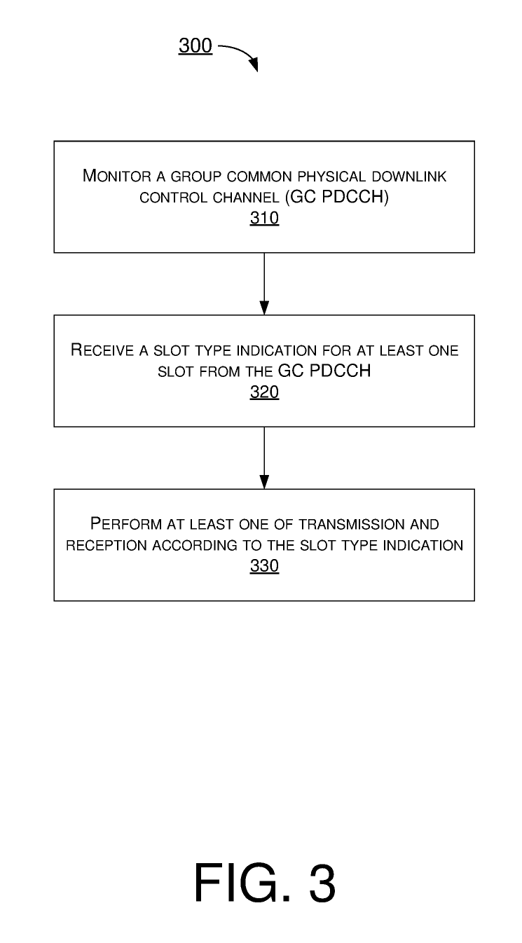

FIG. 3 illustrates an example process 300 in accordance with an implementation of the present disclosure. Process 300 may be an example implementation of scenario 100, whether partially or completely, with respect to GC PDCCH design in accordance with the present disclosure. Process 300 may represent an aspect of implementation of features of communication apparatus 210. Process 300 may include one or more operations, actions, or functions as illustrated by one or more of blocks 310, 320 and 330. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210. Process 300 may begin at block 310.

At 310, process 300 may involve communication apparatus 210 monitoring a group common physical downlink control channel (GC PDCCH). Process 300 may proceed from 310 to 320.

At 320, process 300 may involve communication apparatus 210 receiving a slot type indication for at least one slot from the GC PDCCH. Process 300 may proceed from 320 to 330.

At 330, process 300 may involve communication apparatus 210 performing at least one of transmission and reception according to the slot type indication.

In some implementations, the slot type indication may comprise at least one of a downlink slot, an uplink slot, a downlink priority slot and an uplink priority slot. The slot type indication may indicate a slot type for a slot or for a plurality of slots.

In some implementations, process 300 may involve communication apparatus 210 receiving slot type parameters from the GC PDCCH. The slot type parameters may comprise timing for performing clear channel assessment (CCA). Process 300 may further involve communication apparatus 210 performing the CCA according to the slot type parameters.

In some implementations, process 300 may involve communication apparatus 210 receiving slot type parameters from the GC PDCCH. The slot type parameters may indicate whether to transmit a busy signal. Process 300 may further involve communication apparatus 210 determining whether to transmit the busy signal according to the slot type parameters.

In some implementations, process 300 may involve communication apparatus 210 receiving slot type parameters from the GC PDCCH. The slot type parameters may comprise a power detection threshold. Process 300 may further involve communication apparatus 210 determining whether to transmit uplink signals according to the power detection threshold.

In some implementations, process 300 may involve communication apparatus 210 receiving slot type parameters from the GC PDCCH. The slot type parameters may comprise an uplink power control rule. Process 300 may further involve communication apparatus 210 transmitting uplink signals according to the uplink power control rule.

In some implementations, process 300 may involve communication apparatus 210 receiving the slot type parameters from a radio resource control (RRC) signaling.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
monitoring, by a processor of an apparatus, a group common physical downlink control channel (GC PDCCH);
receiving, by the processor, a slot type indication for at least one slot from the GC PDCCH; and
performing, by the processor, at least one of transmission and reception according to the slot type indication.

2. The method of claim 1, wherein the slot type indication comprises at least one of a downlink slot, an uplink slot, a downlink priority slot and an uplink priority slot.

3. The method of claim 1, wherein the slot type indication indicates a slot type for a plurality of slots.

4. The method of claim 1, further comprising:
receiving, by the processor, slot type parameters from the GC PDCCH; and
performing, by the processor, clear channel assessment (CCA) according to the slot type parameters,
wherein the slot type parameters comprise timing for performing the CCA.

5. The method of claim 1, further comprising:
receiving, by the processor, slot type parameters from the GC PDCCH; and
determining, by the processor, whether to transmit a busy signal according to the slot type parameters,
wherein the slot type parameters indicate whether to transmit the busy signal.

6. The method of claim 1, further comprising:
receiving, by the processor, slot type parameters from the GC PDCCH; and
determining, by the processor, whether to transmit uplink signals according to a power detection threshold,
wherein the slot type parameters comprise the power detection threshold.

7. The method of claim 1, further comprising:
receiving, by the processor, slot type parameters from the GC PDCCH; and
transmitting, by the processor, uplink signals according to an uplink power control rule,
wherein the slot type parameters comprise the uplink power control rule.

8. The method of claim 1, further comprising:
receiving, by the processor, slot type parameters from a radio resource control (RRC) signaling.

9. An apparatus, comprising:
a transceiver capable of wirelessly communicating with a plurality of nodes of a wireless network; and
a processor communicatively coupled to the transceiver, the processor capable of:
monitoring, via the transceiver, a group common physical downlink control channel (GC PDCCH);
receiving, via the transceiver, a slot type indication for at least one slot from the GC PDCCH; and
performing at least one of transmission and reception according to the slot type indication.

10. The apparatus of claim 9, wherein the slot type indication comprises at least one of a downlink slot, an uplink slot, a downlink priority slot and an uplink priority slot.

11. The method of claim 9, wherein the slot type indication indicates a slot type for a plurality of slots.

12. The apparatus of claim 9, wherein the processor is further capable of:
receiving, via the transceiver, slot type parameters from the GC PDCCH; and
performing clear channel assessment (CCA) according to the slot type parameters,
wherein the slot type parameters comprise timing for performing the CCA.

13. The apparatus of claim 9, wherein the processor is further capable of:
receiving, via the transceiver, slot type parameters from the GC PDCCH; and
determining whether to transmit a busy signal according to the slot type parameters,
wherein the slot type parameters indicate whether to transmit the busy signal.

14. The apparatus of claim 9, wherein the processor is further capable of:
receiving, via the transceiver, slot type parameters from the GC PDCCH; and
determining whether to transmit uplink signals according to a power detection threshold,
wherein the slot type parameters comprise the power detection threshold.

15. The apparatus of claim 9, wherein the processor is further capable of:
receiving, via the transceiver, slot type parameters from the GC PDCCH; and
transmitting, via the transceiver, uplink signals according to an uplink power control rule,
wherein the slot type parameters comprise the uplink power control rule.

16. The apparatus of claim 9, wherein the processor is further capable of:
receiving, via the transceiver, slot type parameters from a radio resource control (RRC) signaling.
